(19) United States
(12) Patent Application Publication
(10) Pub. No.: US 2004/0016513 A1
(43) Pub. Date: Jan. 29, 2004

(54) Venetian blind

(76) Inventor: Chien Hua Hung, Taipei (TW)

Correspondence Address: Leong C. Lei, PMB #1008, 1867 Ygnacio Valley Road, Walnut Creek, CA, 94598-3214, US

(21) Appl. No.: 10/206,181

(22) Filed: Jul. 29, 2002

(51) Int. Cl. E06B 3/48

(52) U.S. Cl. 160/84.06

(57) ABSTRACT

An improved structure of a Venetian blind allows easy operation by having a lift cord to take a turn at where it enters and leaves the head rail and the buttermilk to form a certain support force to hold both of the head rail and the buttermilk in position so that one may forthwith press down or push up either of the head rail and the buttermilk to adjust the height of the blind for admitting or shading the sunlight as desired without leaving the lift cord to drop on the floor area to prevent it from tangling a child.

### BACKGROUND OF THE INVENTION

(a) Field of the Invention

The present invention is related to an improved structure of a Venetian blind, and more particularly, to one that the blind is moved up and down by directly pushing the head rail or the bottom rail, and the lift cord will not hang around close to the floor for safety reason.

(b) Description of the Prior Art

To allow more sunlight into the building, more windows are required. However, direct sunshine is not necessarily required particularly during hot summer days. Therefore, curtains, roller shade, curtain, and Venetian blind are available to cover up the window and to stop the direct sunshine. As illustrated in FIG. 1 of the accompanying drawings, a blind 13 is provided between a head rail 11 and a bottom rail 12. Close to both ends above the head rail 11 is each connected to a fixation mechanism 2 while a lift cord each 14, 15 penetrates through the blind 13 from both sides of the head rail 11 down to the bottom rail 12. A retainer 16, 17 is each inserted to the lift cord 14, 15 below the buttermilk 12 to stop and hold the buttermilk 12 in position. Both retainers 16, 17 hold the blind at the height as elevated or descended by both lift cords 14, 15.

Another prior art of a Venetian blind 3 as illustrated in FIG. 2, also has a blind 33 provided between a head rail 31 and a bottom rail 32 and both ends above the head rail 31 are respectively linked to a fixation mechanism 4. A lift cord lock 34 is provided on either side of the head rail 31. Meanwhile, a lift cord 35 penetrating through the lift cord lock 34, then following the head rail 31 to penetrate downward through the blind 33 and the bottom rail 32 from both sides and the center to be fastened at the bottom of the bottom rail 32. Accordingly, once the lift cord is pulled to elevate or descend the bottom rail 32, the blind 33 drops or rises to achieve the purpose of adjusting the height of the blind 33.

As far as the structure of both prior art described above is concerned, the blind can be lifted to admit the direct sunshine or to shade it. However, the elevating of the blind is controlled by lifting the bottom rail. That is, the blind gradually drops or rises merely by the movement of the blind; it prevents the sunshine entering from the upper side of the blind. Furthermore, once the blind is lifted up, it is at the cost of the privacy of the occupant.

Therefore, an improved structure of a Venetian blind 5 has been developed as illustrated in FIG. 3. Similarly, a blind 53 is provided between a head rail 51 and a bottom rail 52. A frame 6 is fixed above the upper window pane (not illustrated) and a lift cord lock mechanism 61,62 is each respectively provided on both sides of the frame 6 while two lift cords 54, 55 respectively penetrate through the lock mechanism 61, 62 into the frame 6, then the head rail 51 and both sides and the center of the blind 53, and is finally fastened at the bottom of the bottom rail 52, wherefrom the head rail 51 and the bottom rail 52 are respectively controlled by the lift cord 54 through the lift cord lock mechanism 61 and 62. That is, both of the head rail 51 and the bottom rail 52 can be independently elevated or descended respectively the lift cords 54,55. Now referring to FIG. 4, the head rail 51 moves downward as driven by the lift cord 54, or as illustrated in FIG. 5, the bottom rail 52 moves upward as driven by the lift cord 55. Accordingly, the sunlight is admitted either by lowering the head rail 51 or by elevating the bottom rail 52, or to cover up the entire blind 5 as desired. However, the production of the entire set is comparatively complicate and higher production cost. Furthermore, one end of the lift cord is left falling one the ground which may tangle a child's neck, thus to suffocate the child. Therefore, it is necessary to design a Venetian blind structure that is safe, simple and meeting requirements of admitting the sunshine as desire.

### SUMMARY OF THE INVENTION

The primary purpose of the present invention is to provide an improved structure of a Venetian blind that the height of either the head rail or the bottom rail can be easily adjusted as desired by directly pushing the head rail or the bottom rail to elevate or descend the blind.

Another purpose of the present invention is to provide an improved structure of a Venetian blind without leaving its lift cord to fall on the floor to prevent accident since a child may be tripped and tangled by the lift cord on the floor.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view of a Venetian blind of the prior art.

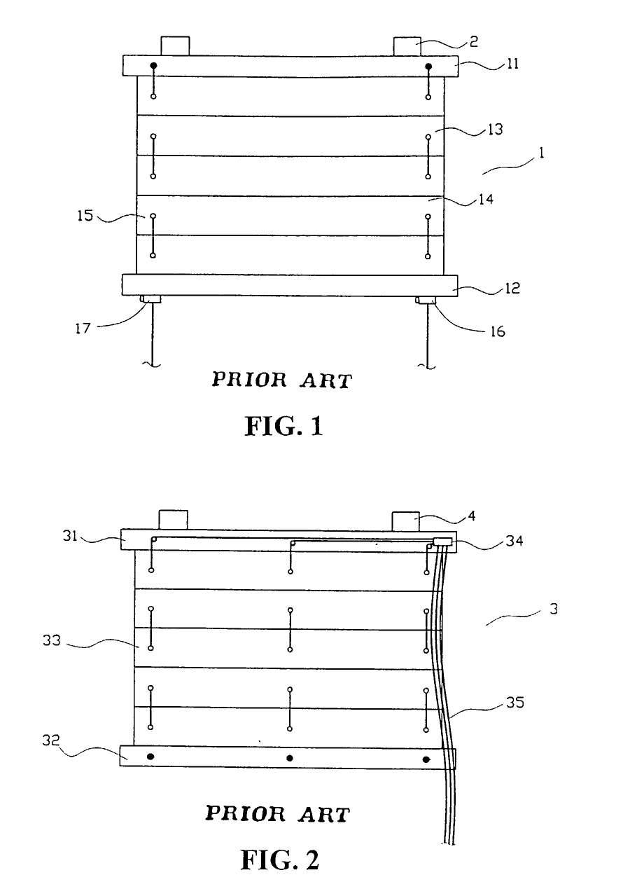

FIG. 2 is a front view of another Venetian blind of the prior art.

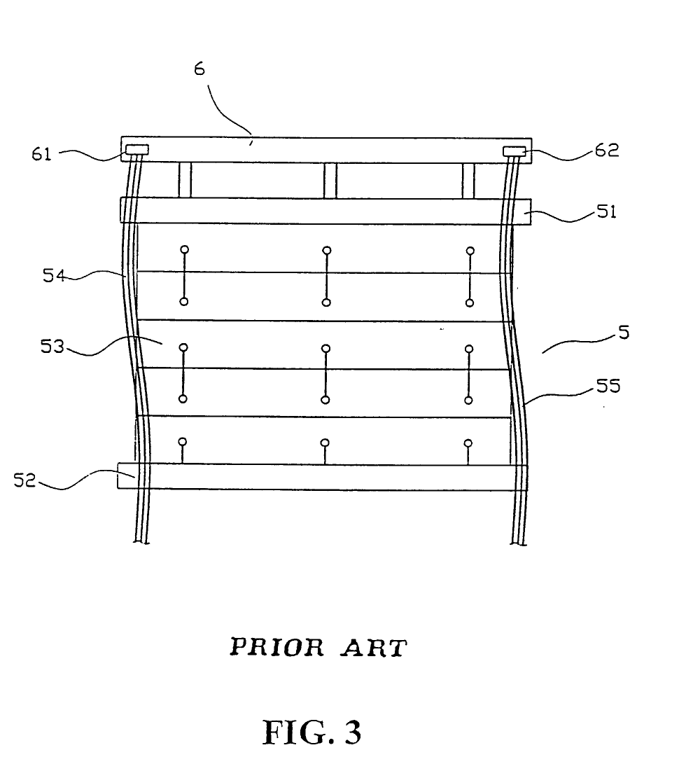

FIG. 3 is a front view of another Venetian blind yet of the prior art.

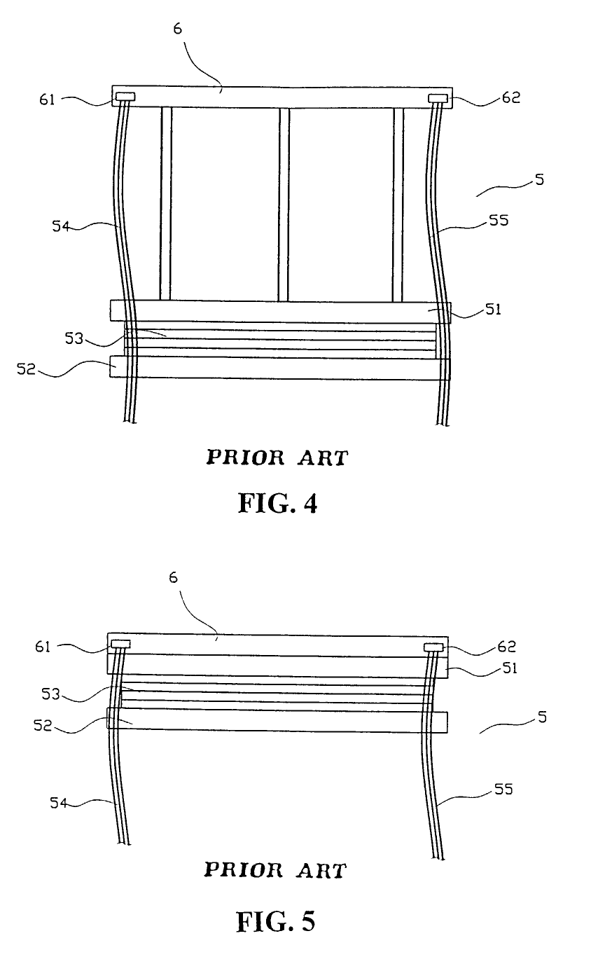

FIG. 4 is a schematic view showing an application of the Venetian blind taken from FIG. 3.

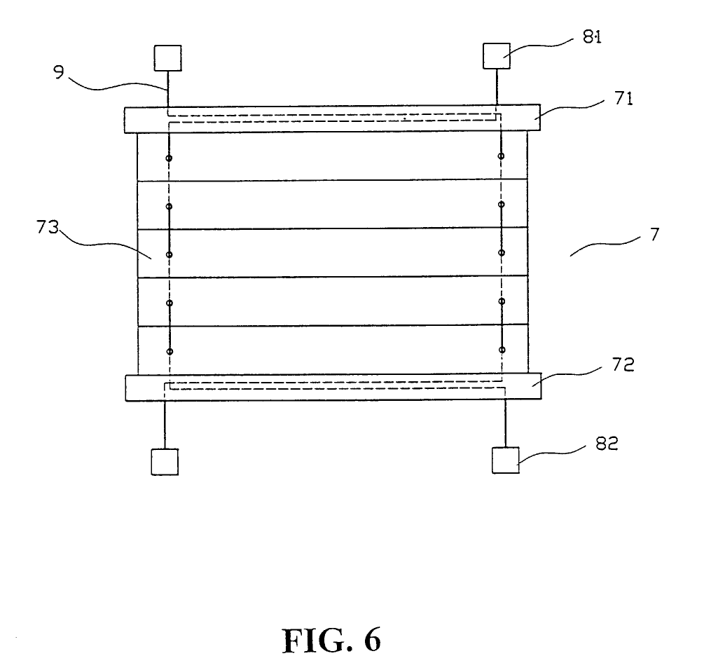

FIG. 5 is a schematic view showing another application of the Venetian blind taken from FIG. 3.

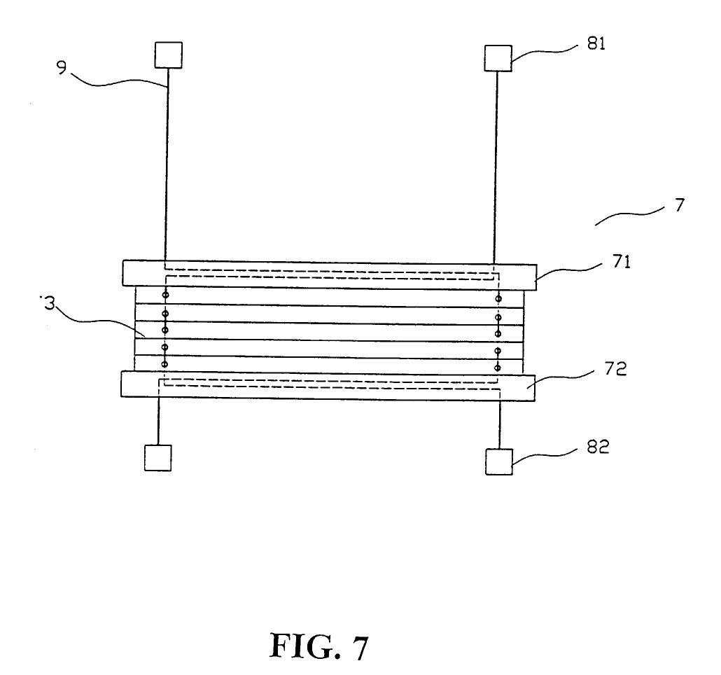

FIG. 6 is a front view showing a preferred embodiment of the present invention.

FIG. 7 is a schematic view showing an application of the present invention.

FIG. 8 is a schematic view showing another application of the present invention.

FIG. 9 is a schematic view showing another application yet of the present invention.

FIG. 10 is a schematic view showing further another application yet of the present invention.

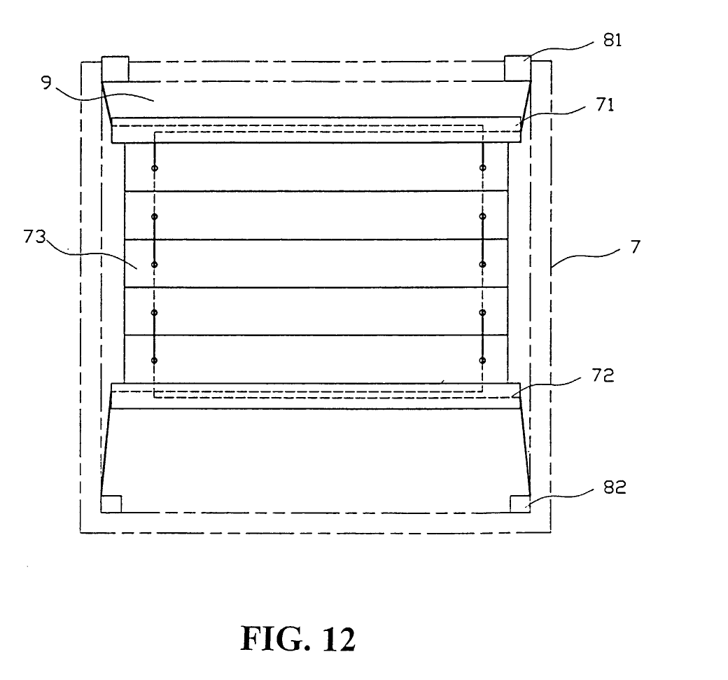

FIG. 11 is a front view of a second preferred embodiment of the present invention.

FIG. 12 is a front view of a third preferred embodiment of the present invention.

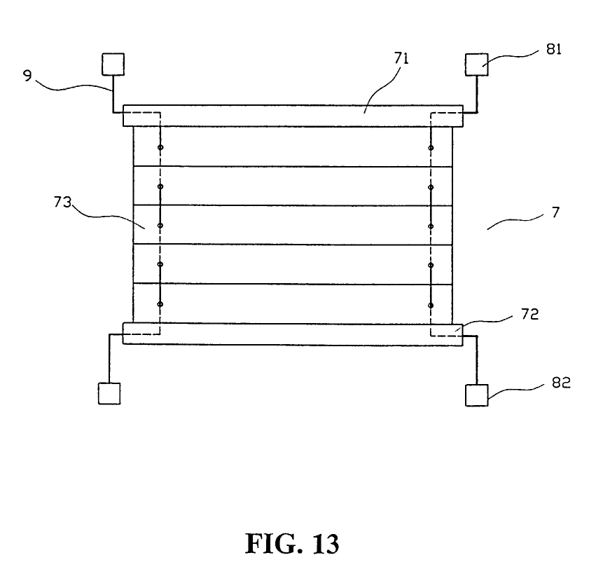

FIG. 11 is a front view of a fourth preferred embodiment of the present invention.

FIG. 11 is a front view of a fifth preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

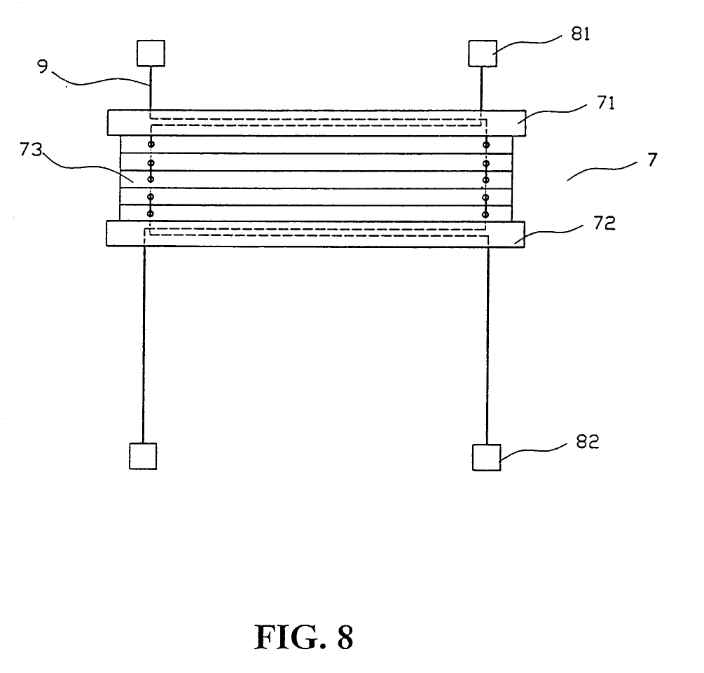

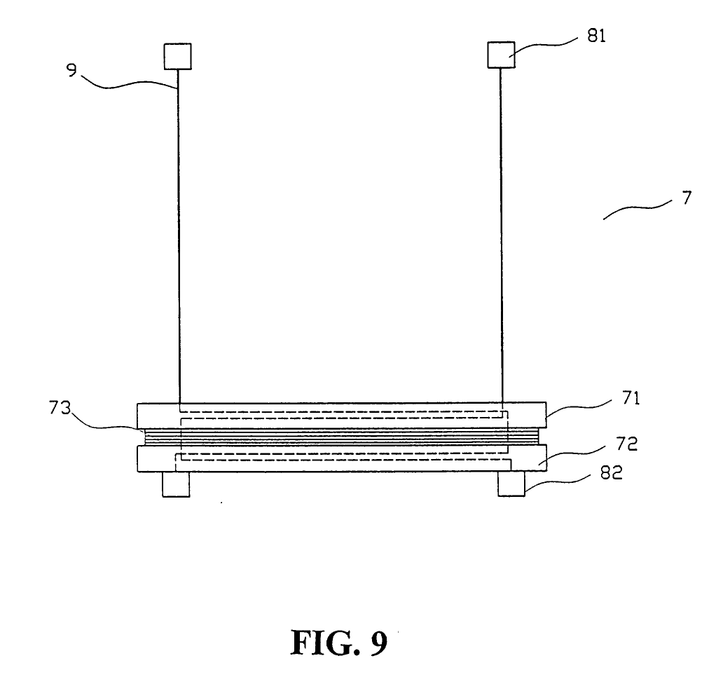

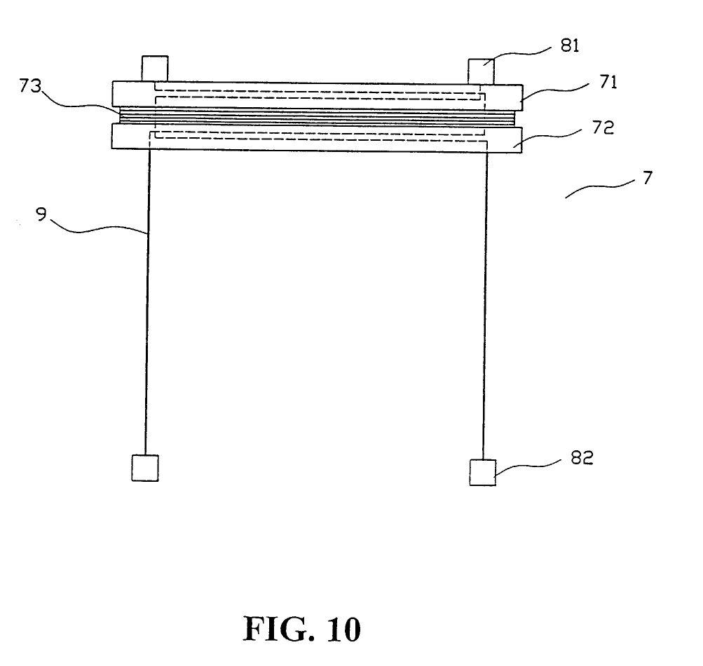

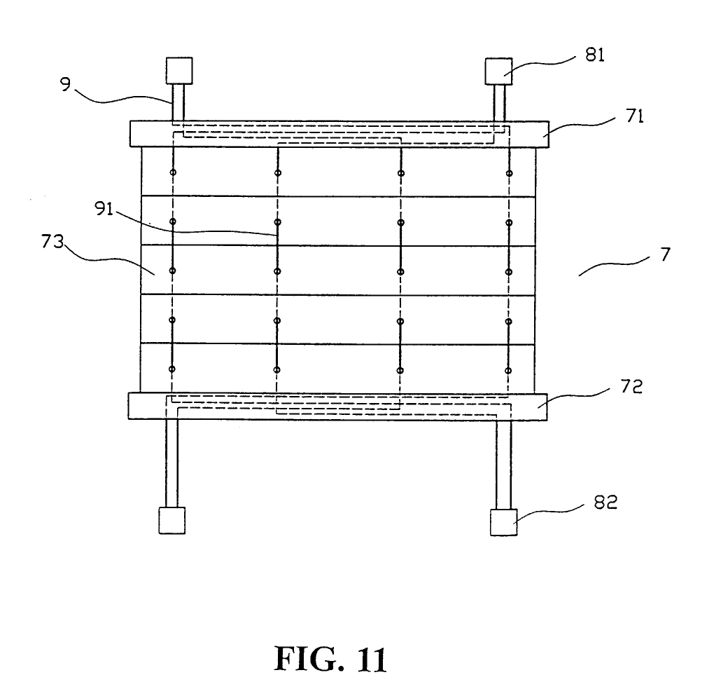

Referring to FIG. 6, a preferred embodiment of a Venetian blind 7 has provided a blind 73 between an upper head rail 71 and a bottom rail 72; and a lift cord lock mechanism 81 and a lift cord lock mechanism 82 are respectively provided on an upper and a lower window panes (not illustrated). One end of a lift cord 9 penetrates from the upper lock mechanism 81 to the right into the head rail 71, then laterally travels to its left and forthwith enters from the left side of the head rail 71 through the blind 73, into the left side of the bottom rail 72, take a turn to laterally travel to its right and straight downward from the right of bottom rail 72 to be finally fastened in the lower right lock mechanism 82. Wherein, said end of the lift cord 9 may be tied with a knot or secured by a latching device in the lock mechanism 82. Furthermore, another end of the lift cord 9 penetrates from the upper lock mechanism 81 to the left penetrates downward thought the head rail 71, then takes a turn to travel to the right of the head rail 71 to further penetrate from the right of the head rail 71 through the blind 73, and to enter into the right side of the bottom rail 72 to take a turn to travel to its left, finally moves downward from the left side of the head rail 72 into and is fastened to the lower lock mechanism 82 on the left of bottom rail 72. Again, said another end of the lift cord 9 may be tied with a knot or secured by a latching device in the lock mechanism 82. In practice, one lift cord 9 or two lift cords 9 may be used to complete the same penetration as disclosed above. In either case, the end of the lift cord 9 in the upper lock mechanism 81 must be fastened after having adjusted it for achieving a proper tension.

Whereas, the lift cord 9 stays flush laterally inside the head rail 71 and the bottom rail 72, where the lift cord 9 takes the turn to enter the head rail 71 and the bottom rail respectively defines a certain resistance. Since all the components of the Venetian blind are made of light-weight material, such resistance is sufficient to create a certain support force to hold both of the head rail 71 and the bottom rail 72 in position, making both of the head rail 71 and the bottom rail 72 to be held in position without being subject to any external force. Neither the head rail 71 nor the bottom rail will move as long as it is not subject to external force. However, once it is pressed or pushed by external force, either will elevate or descend. As illustrated in FIG. 7, one use his either hand to press the head rail 71 for it to move toward the bottom rail 72 for the Venetian blind 7 to open up its upper space to admit the sunshine entering into the room while the lower space remains closed to keep away the sunshine without compromising the lighting effect. Or, alternatively as illustrated in FIG. 8, the bottom rail 72 is pushed up by hand to move close to the head rail 71, thus to open up the lower space of the Venetian blind 7 to admit the sunshine. As illustrated in FIG. 9, the head rail 71 is pressed towards the bottom rail 72, or as illustrated in FIG. 19, the bottom rail 72 is pushed up towards the head rail 71 to close up both of the head rail 71 and the bottom rail 72 against each other on the top or at the bottom of the Venetian blind for the window to fully admit the sunshine.

Now referring to FIG. 11 for a second preferred embodiment of the present invention, the preferred embodiment relates to a wider Venetian blind, wherein, both of said lift cords 9 may not be sufficient to support the blind 73. Therefore, an additional lift cord 91 may be used each to penetrate through the same route as that for the lift cord 9 with the only exception that the lift cord 91 travels behind the blind 73 by keeping in parallel with the lift cord 9 penetrating through the front surface of the blind 73 to support the Venetian blind 7 jointly with the existing lift cord 9 to make it easy and smooth to press or to push either of the head rail 71 and the bottom rail 72.

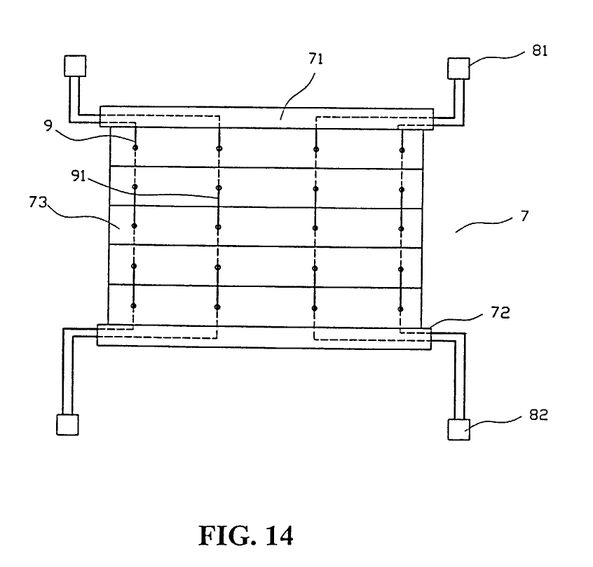

As illustrated in FIG. 12 for a third preferred embodiment of the present invention, wherein, both lift cords 9 from both sides penetrate from both sides of the head rail 71 into the head rail 71, take the turn to travel through the blind 73 and extend into the bottom rail 72 before being fastened in the lower lock mechanism 82 respectively fixed to the window pane (as shown in dotted line) so to take advantage of the window pane to cover up the lift cords 9. Accordingly, once the bottom rail 72 is pushed up, no trace of said two lift cords 9 is visible on the window to improve the appearance in general.

As illustrated in FIGS. 13 and 14 for a fourth and a fifth preferred embodiments of the present invention, wherein, whether a Venetian blind 7 is penetrated through with two or four lift cords 9, once the lift cord 9 enters into the head rail 71, it may forthwith takes a turn downward after traveling a small distance to penetrate through the blind 73, and, similarly, it may forthwith leave the bottom rail 72 after traveling a small distance to be fastened in the lock mechanism 82 below while moving the blind to elevate or descend the same by pressing the head rail 71 or by pushing up the bottom rail 72.

As disclosed, the present invention is characterized by that one may directly press down the head rail or push up the bottom rail to force the head rail or the bottom rail to move close or away from each other to admit or to close up the opening space of the Venetian blind 7 as desired. The present invention allows an easy manual operation only by means of the lift cord 9 for production cost reduction while it is safe to operate by keeping the lift cord 9 to stay clear from the floor to completely eliminate the hazard of tangling a child.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a Venetian blind comprised of a head rail, a buttermilk, a blind between the head rail and the bottom rail, a lift cord, two upper lock mechanisms above the head rail and two lower lock mechanism below the buttermilk, wherein, one end of the lift cord penetrates thought the upper right lock mechanism to into the head rail, takes a turn to travel laterally to leave the left side of the head rail to penetrate downward through the blind to enter into the left side of the bottom rail, takes another turn to travel through the buttermilk and to leave it to be fastened in the right lower lock mechanism; and the other end of the lift cord penetrates thought the upper left lock mechanism to into the head rail, takes a turn to travel laterally to leave the right side of the head rail to penetrate downward through the blind to enter into the right side of the bottom rail, takes another turn to travel through the buttermilk and to leave it to be fastened in the left lower lock mechanism characterized by that a certain support is formed by the lift cords at where they take the turns to respectively enter into the head rail and the bottom rail for the lift cords to be held in position at any height as desired depending on how much sunlight will be admitted or shaded.

2. An improved structure of a Venetian blind as claimed in claim 1, wherein, two lift cords are used to respectively penetrate the blind from the upper lock mechanisms fixed on both sides.

3. An improved structure of a Venetian blind as claimed in claim 1, wherein, more than two lift cords are used to penetrate through the blind.

4. An improved structure of a Venetian blind as claimed in claim 1, wherein, the lift cord after entering into the bottom rail may take another turn after it leaves the bottom rail to travel vertically to be fastened so that the lift cord is covered up by the windowpane.
